(19) United States
(12) Patent Application Publication
(10) Pub. No.: US 2011/0048000 A1
(43) Pub. Date: Mar. 3, 2011

(54) Turbine or compressor, in particular for a turbo-compound system

(75) Inventors: Markus Kley, Ellwangen (DE); Michael Wiedmann, Alfdorf (DE)

(73) Assignee: Voith Patent GmbH (Germany)

(21) Appl. No.: 12/806,163

(22) Filed: Aug. 6, 2010

(30) Foreign Application Priority Data
Aug. 27, 2009 (DE) 102009038736.6

(51) Int. Cl. F02B 33/44

(52) U.S. Cl. 60/598

(57) ABSTRACT

The invention relates to a turbine, in particular an exhaust gas power turbine for a turbo-compound system, comprising
a drive shaft, which carries a turbine wheel on its first end or in the area of the first end, which is intended for positioning in an exhaust gas stream of an internal combustion engine or another medium stream containing thermal and/or pressure energy, in order to convert exhaust gas energy or energy of the medium stream into drive power, and
which carries a gearwheel on its second end or in the area of the second end, which is designed for the purpose of being placed in a drive connection with the crankshaft of the internal combustion engine,
the drive shaft being mounted, at least in the area of its second end adjacent to the gearwheel, using a floating bush in a housing, which forms an outer oil-filled bearing gap in relation to the housing and an inner oil-filled bearing gap in relation to the drive shaft and is relatively rotatable in relation to the housing and the drive shaft.

The invention is characterized in that
the relative bearing play of the outer bearing gap, which is defined as the difference between the inner diameter of the housing in the bearing and the outer diameter of the floating bush in the bearing, divided by the outer diameter of the floating bush in the bearing, is less than the relative bearing play of the inner bearing gap, which is defined as the difference between the inner diameter of the floating bush in the bearing and the outer diameter of the drive shaft in the bearing, divided by the outer diameter of the drive shaft in the bearing.

The present invention relates to a turbine, such as a gas turbine or steam turbine, in particular an exhaust gas power turbine for a turbo-compound system, specifically having the features according to the preamble of Claim 1. Furthermore, the present invention relates to a turbocompressor for a turbo-compound system or a turbocharger according to the preamble of Claim 7.

Turbo-compound systems and exhaust gas power turbines for this purpose are known to those skilled in the art. In contrast to exhaust gas turbines for turbochargers, the drive shaft of such an exhaust gas power turbine for a turbo-compound system does not have a compressor impeller on the end distant from the turbine wheel (impeller of the exhaust gas turbine), but rather a drive gearwheel, also referred to as a drive pinion. The replacement of the compressor wheel by a drive gearwheel has effects on the forces which act on the mounting of the drive shaft in operation. In practice, it has been shown that these forces may deviate from those which occur in the mounting of an exhaust gas turbocharger shaft in such a manner that design measures must be taken to prevent damage to the mounting and thus a breakdown of the turbo-compound system.

Thus, patent specification EP 1 197 638 61 already describes that, on a drive shaft of an exhaust gas power turbine for a turbo-compound system, which carries a drive gearwheel, different forces act on the bearing system of the drive shaft than in the case of a typical turbocharger, which “only” drives a compressor. It is thus assumed that in the case of a typical turbocharger, vibration forces and forces from an imbalance due to oil films are absorbed by the mounting, which are distributed uniformly in an outer bearing gap and an inner bearing gap of a floating bush mounting. In contrast, in a turbo-compound system, a reaction force would act on the drive shaft through the drive gear wheel, which significantly increases the strain of the oscillating bush bearing, in particular the one which is positioned adjacent to the gearwheel.

In order to reliably control this increased strain, document EP 1 197 638 B1 proposes as a solution that the first bearing adjacent to the turbine wheel and the second bearing adjacent to the gearwheel be mechanically coupled to one another in such a manner that they rotate at the same speed in relation to the housing. This can be achieved, for example, by a one-piece floating bush, which extends along the entire drive shaft from the first bearing up into the second bearing.

Although a solution was thus found which deals with the special problem of the forces acting on the drive shaft in operation of a turbo-compound system, the proposed embodiment provides a comparatively complex solution which is costly to produce, which particularly meets its limits if either the bearing adjacent to the gearwheel is situated comparatively far away from the bearing adjacent to the turbine wheel, in particular if the bearing adjacent to the gearwheel is positioned on the side of the gearwheel facing away from the turbine wheel, or if a further, third bearing is provided between the two bearings.

The invention is based on the object of specifying a turbine, in particular an exhaust gas power turbine for a turbo-compound system, which, on the one hand, reliably controls the described forces occurring in operation of the turbo-compound system and, on the other hand, does not have the above-mentioned disadvantages. Furthermore, the invention is also to be applicable in a turbocompressor on a drive shaft which carries the compressor impeller on one end and a gearwheel on its other end, if the same force conditions occur here.

The object according to the invention is achieved by a turbine having the features of Claim 1 and a turbocompressor having the features of Claim 7. Advantageous and particularly expedient embodiments of the invention are specified in the dependent Claims.

The invention shows a possible solution which completely reverses the prevailing teaching in the design of a floating bush bearing. Specifically, the conventional design (U.S. Pat. No. 4,427,309, page 4, second paragraph) thus always provides implementing the outer bearing gap, which is formed between the outer circumference of the floating bush and the opposing inner circumference of the housing, having a greater relative bearing play than the inner bearing gap, which is formed by the inner circumference of the floating bush and the outer opposing circumference of the drive shaft. The finding that the inner bearing gap is to assume the bearing function more strongly and the outer bearing gap is to assume the damping function more strongly is behind this layout.

The relative bearing play is defined for the outer bearing gap by the inner diameter of the housing minus the outer diameter of the floating bush, i.e., the difference between these two diameters, divided by the outer diameter of the floating bush. The relative bearing play of the inner bearing gap is defined as the inner diameter of the floating bush minus the outer diameter of the drive shaft, i.e., the difference of these two diameters, divided by the outer diameter of the drive shaft. The definition of the relative bearing play accordingly always relates to the respective smaller diameter.

According to the invention, the relative bearing play of the inner bearing gap is implemented as greater than the relative bearing play of the outer bearing gap, at least or exclusively in the case of the bearing in the area of the end or on the end of the drive shaft which carries the gearwheel and thus facing away from the end of the drive shaft on which or in the area of which the turbine wheel is situated or carried. According to a first embodiment, the bearing implemented according to the invention is situated on the side of the gearwheel facing away from the turbine wheel. According to an alternative embodiment, in which the gearwheel is mounted overhung in particular, the bearing implemented according to the invention is situated on the side facing toward the turbine wheel adjacent to the gearwheel of the drive shaft.

The gearwheel is designed for the purpose of being brought into a drive connection with the crankshaft of the internal combustion engine. In contrast, the turbine wheel is designed to be positioned in an exhaust gas stream of the internal combustion engine so that it converts exhaust gas energy into drive power and drives the gearwheel to rotate via the drive shaft. Using the gearwheel, the drive power is transmitted directly or via a further interposed trains of gears to the crankshaft of the internal combustion engine, in order to drive it.

The bearing adjacent to the turbine wheel can also be implemented as a floating bush bearing, i.e., comprise a floating bush which is mounted in a housing and forms an outer bearing gap in relation to the housing and an inner bearing gap in relation to the drive shaft, the floating bush being rotatable both relatively in relation to the housing and also relatively in relation to the drive shaft. The bearing gaps are oil-filled, which does not mean that they must be completely and continuously filled with oil. However, an oil film is advantageously formed over the entire circumference of the bearing gap at every moment in operation of the exhaust gas power turbine, advantageously having a comparatively constant thickness.

The relative bearing play of the outer bearing gap in the bearing adjacent to the gearwheel is advantageously in the range between 2 and 4 parts per thousand. The relative bearing play of the inner bearing gap of the bearing adjacent to the gearwheel is advantageously in the range of 3 to 5 parts per thousand, presuming, however, that the relative bearing play of the inner bearing gap is greater than the relative bearing play of the outer bearing gap, as shown.

According to one embodiment, the drive shaft can have and advantageously carry, adjacent to the turbine wheel and the gearwheel, a compressor impeller, in particular of a fresh air compressor, which is situated in a fresh air stream supplied to the internal combustion engine to charge the internal combustion engine, the compressor impeller being able to be positioned on the second end or in the area of the second end, for example, thus adjacent to the gearwheel. For example, the bearing implemented according to the invention can be positioned on the second end between the compressor impeller, which is advantageously mounted overhung on the drive shaft, and the gearwheel.

According to one embodiment, the drive shaft is further mounted using a third bearing between the first bearing adjacent to the gearwheel and the second bearing adjacent to the turbine wheel, this third bearing in particular also having a floating bush. If two floating bush bearings are positioned directly adjacent to the gearwheel in this manner, these two bearings are advantageously both implemented according to the invention, i.e., they have a comparatively large relative bearing play in the inner bearing gap, compared to the relative bearing play in the outer bearing gap. However, it can also be sufficient to implement only one of the two bearings accordingly, and to implement the other having a comparatively greater relative bearing play in the outer bearing gap. In the latter case, in particular the floating bush bearing placed further away from the turbine wheel has the comparatively greater relative bearing play in the inner bearing gap.

If the bearing adjacent to the turbine wheel is also implemented as a floating bush bearing, it advantageously has a greater relative bearing play in the outer bearing gap, compared to that in the inner bearing gap. Of course, however, a reverse embodiment is also conceivable.

Although the invention has been described above on the basis of an exhaust gas power turbine for a turbo-compound system, which is situated in the exhaust gas stream of an internal combustion engine, the invention is also applicable in other turbines which are positioned in a medium stream containing thermal and/or pressure energy, in order to convert energy from the medium stream into drive power. For example, the turbine can be implemented as a steam turbine, which is situated in a steam stream. In particular, exhaust gas energy can in turn be used for steam generation, in that a corresponding heat exchanger or vaporizer is situated in the exhaust gas stream.

The teaching according to the invention is also applicable in the case of a turbocompressor whose compressor wheel is positioned on the first end or in the area of the first end of a drive shaft, the drive shaft carrying a gearwheel on its second end or in the area of the second end. In this case, the above-described statements apply accordingly, however, instead of the turbine wheel, the compressor wheel being situated and accordingly not converting energy of a medium stream into drive power, but rather drive power being used for the purpose of compressing the fresh air stream to an internal combustion engine. The drive power is introduced via the gearwheel on the second end or in the area of the second end of the drive shaft and can be made available, for example, by the crankshaft of the internal combustion engine and/or by an exhaust gas turbine in the exhaust gas stream of the internal combustion engine. Fundamentally, other energy sources would also be usable, for example, a steam turbine in a steam loop, the steam in particular again being generated by exhaust gas energy.

The invention will be explained for exemplary purposes hereafter on the basis of an exemplary embodiment.

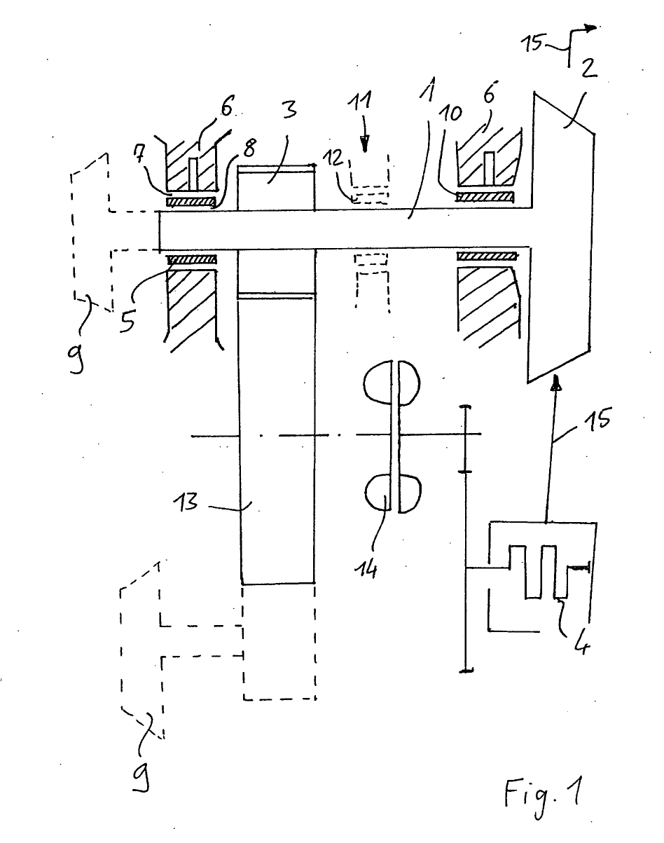

FIG. 1 schematically shows an exhaust gas power turbine implemented according to the invention for a turbo-compound system, comprising a drive shaft 1, which carries a turbine wheel 2 in the area of its first end and/or on its first end here, and carries a gearwheel 3 in the area of its second end. The gearwheel 3 is implemented as a pinion, which meshes with a further gearwheel 13, which has a drive connection via a hydrodynamic clutch 14 to the crankshaft 4 of an internal combustion engine, in whose exhaust gas stream 15 the turbine wheel 2 is situated for exhaust gas energy reclamation.

The drive shaft 1 is mounted in the area of its second end, here on its second end, using a floating bush 5 in a housing 6 of the exhaust gas power turbine and/or the so-called transmission of the turbo-compound system. The floating bush 5 delimits, together with the inner diameter of the housing 6, an outer oil-filled bearing gap 7 and, together with the outer diameter of the drive shaft 1, an inner oil-filled bearing gap 8. According to the invention, the relative bearing play is greater in the inner bearing gap 8 than in the outer bearing gap 7. The oil throughput is thus comparatively increased in the inner bearing gap 8 and a comparatively lower bearing temperature thus results. Although comparatively less damping occurs in the outer bearing gap 7, which is reduced in its height in particular in relation to typical bearing gaps, this is not problematic in the embodiment shown, because the mass of the pinion is reduced in comparison to the mass of a compressor impeller of a typical turbocharger and thus less damping is sufficient. The thermal strain of the outer bearing gap 7 is also comparatively less in comparison to typical turbochargers.

As shown by dashed lines in FIG. 1, according to alternative embodiments, a compressor impeller 9 can additionally be provided in the turbo-compound system implemented according to the invention, which is drivable using the turbine wheel 2 or using the crankshaft 4 and can be used to turbocharge the internal combustion engine. This compressor impeller 9 can mesh via a further pinion with the gearwheel 13 or can be driven by the drive shaft 1 and/or carried thereby, for example. Other embodiments are conceivable.

In the embodiment shown, the bearing adjacent to the turbine wheel is also implemented having a floating bush 10 and mounted in the housing 6. Of course, it would also be possible to provide this mounting in another component, in particular a separate housing.

As further indicated by dashed lines, a third bearing 11 can be provided in the area between the bearing adjacent to the gearwheel 3 and the bearing adjacent to the turbine wheel 2, which is also implemented in particular as a floating bush bearing having a floating bush 12.

Although a turbo-compound system is shown in FIG. 1, the illustration could also be used to describe a turbocompressor, in which the compressor wheel is specifically positioned at the location of the turbine wheel 2 and in particular compresses a fresh air stream to the internal combustion engine (the arrows on the line 15 must be reversed accordingly). The drive power could either be provided by the crankshaft 4 of the internal combustion engine or by an exhaust gas turbine, which could be positioned instead of the position 9, for example. The exhaust gas turbine is accordingly impinged by an exhaust gas stream of the internal combustion engine. The position would preferably be that which is shown on the bottom in FIG. 1, but the position of the number 9 at the top left in FIG. 1 could also come into consideration.

1-12. (canceled)

13. A turbine, in particular an exhaust gas power turbine for a turbo-compound system, comprising:
a drive shaft, which carries a turbine wheel on its first end or in the area of the first end, which is intended for positioning in an exhaust gas stream of an internal combustion engine or another medium stream containing thermal and/or pressure energy, in order to convert exhaust gas energy or energy of the medium stream into drive power, and
which carries a gearwheel on its second end or in the area of the second end, which is designed for the purpose of being placed in a drive connection to the crankshaft of the internal combustion engine,
the drive shaft, at least in the area of its second end adjacent to the gearwheel, being mounted using a floating bush in a housing, which forms an outer oil-filled bearing gap in relation to the housing and an inner oil-filled bearing gap in relation to the drive shaft and is relatively rotatable in relation to the housing and the drive shaft,
characterized in that
the relative bearing play of the outer bearing gap, which is defined as the difference between the inner diameter of the housing in the bearing and the outer diameter of the floating bush in the bearing, divided by the outer diameter of the floating bush in the bearing, is less than the relative bearing play of the inner bearing gap, which is defined as the difference between the inner diameter of the floating bush in the bearing and the outer diameter of the drive shaft in the bearing, divided by the outer diameter of the drive shaft in the bearing.

14. The turbine according to claim 13, characterized in that the relative bearing play of the outer bearing gap is in the range from 2 to 4 parts per thousand and the relative bearing play of the inner bearing gap is in the range from 3 to 5 parts per thousand.

15. The turbine according to claim 13, characterized in that the drive shaft also carries a compressor impeller, in particular on its second end.

16. The turbine according to claim 14, characterized in that the drive shaft also carries a compressor impeller, in particular on its second end.

17. The turbine according to claim 13, characterized in that the floating bush is positioned on the side of the gearwheel facing away from the turbine wheel, and the drive shaft is mounted using two bearings, one adjacent to the gearwheel and one adjacent to the turbine wheel.

18. The turbine according to claim 14, characterized in that the floating bush is positioned on the side of the gearwheel facing away from the turbine wheel, and the drive shaft is mounted using two bearings, one adjacent to the gearwheel and one adjacent to the turbine wheel.

19. The turbine according to claim 15, characterized in that the floating bush is positioned on the side of the gearwheel facing away from the turbine wheel, and the drive shaft is mounted using two bearings, one adjacent to the gearwheel and one adjacent to the turbine wheel.

20. The turbine according to claim 16, characterized in that the floating bush is positioned on the side of the gearwheel facing away from the turbine wheel, and the drive shaft is mounted using two bearings, one adjacent to the gearwheel and one adjacent to the turbine wheel.

21. The turbine according to claim 17, characterized in that the drive shall is mounted, in the area of its first end adjacent to the turbine wheel, using a further floating bush in the housing or a further housing, the further floating bush forms an outer oil-filled bearing gap in relation to the housing and an inner oil-filled bearing gap in relation to the drive shaft and is relatively rotatable in relation to the housing and the drive shaft, the relative bearing play of the outer bearing gap being greater than the relative bearing play of the inner bearing gap.

22. The turbine according to claim 18, characterized in that the drive shaft is mounted, in the area of its first end adjacent to the turbine wheel, using a further floating bush in the housing or a further housing, the further floating bush forms an outer oil-filled bearing gap in relation to the housing and an inner oil-filled bearing gap in relation to the drive shaft and is relatively rotatable in relation to the housing and the drive shaft, the relative bearing play of the outer bearing gap being greater than the relative bearing play of the inner bearing gap.

23. The turbine according to claim 19, characterized in that the drive shaft is mounted, in the area of its first end adjacent to the turbine wheel, using a further floating bush in the housing or a further housing, the further floating bush forms an outer oil-filled bearing gap in relation to the housing and an inner oil-filled bearing gap in relation to the drive shaft and is relatively rotatable in relation to the housing and the drive shaft, the relative bearing play of the outer bearing gap being greater than the relative bearing play of the inner bearing gap.

24. The turbine according to claim 20, characterized in that the drive shaft is mounted, in the area of its first end adjacent to the turbine wheel, using a further floating bush in the housing or a further housing, the further floating bush forms an outer oil-filled bearing gap in relation to the housing and an inner oil-filled bearing gap in relation to the drive shaft and is relatively rotatable in relation to the housing and the drive shaft, the relative bearing play of the outer bearing gap being greater than the relative bearing play of the inner bearing gap.

25. The turbine according to claim 21, characterized in that the drive shaft is further mounted using a third bearing between the first bearing adjacent to the gearwheel and the second bearing adjacent to the turbine wheel, which in particular also has a floating bush.

26. A turbocompressor, in particular for a turbo-compound system or a turbocharger, comprising:
a drive shaft, which carries a compressor wheel on its first end or in the area of the first end, which is intended for positioning in a fresh air stream of an internal combustion engine, in order to compress the fresh air stream supplied to the internal combustion engine, and
carries a gearwheel on its second end or in the area of the second end, which is designed for the purpose of being placed in a drive connection to the crankshaft of the internal combustion engine or to a turbine or exhaust gas turbine,
the drive shaft being mounted, at least in the area of its second end adjacent to the gearwheel, using a floating bush in a housing, which forms an outer oil-filled bearing gap in relation to the housing and an inner oil-filled bearing gap in relation to the drive shaft and is relatively rotatable in relation to the housing and the drive shaft,
characterized in that
the relative bearing play of the outer bearing gap, which is defined as the difference between the inner diameter of the housing in the bearing and the outer diameter of the floating bush in the bearing, divided by the outer diameter of the floating bush in the bearing, is less than the relative bearing play of the inner bearing gap, which is defined as the difference between the inner diameter of the floating bush in the bearing and the outer diameter of the drive shaft in the bearing, divided by the outer diameter of the drive shaft in the bearing.

27. The turbocompressor according to claim 26, characterized in that the relative bearing play of the outer bearing gap is in the range from 2 to 4 parts per thousand and the relative bearing play of the inner bearing gap is in the range of 3 to 5 parts per thousand.

28. The turbocompressor according to claim 26, characterized in that the drive shaft further carries a turbine wheel, in particular on its second end.

29. The turbocompressor according to claim 27, characterized in that the drive shaft further carries a turbine wheel, in particular on its second end.

30. The turbocompressor according to claim 26, characterized in that the floating bush is positioned on the side of the gearwheel facing away from the compressor wheel, and the drive shaft is mounted using two bearings, one adjacent to the gearwheel and one adjacent to the compressor wheel.

31. The turbocompressor according to claim 30, characterized in that the drive shaft is mounted, in the area of its first end adjacent to the compressor wheel, using a further floating bush in the housing or a further housing, the further floating bush forms an outer oil-filled bearing gap in relation to the housing and an inner oil-filled bearing gap in relation to the drive shaft and is relatively rotatable in relation to the housing and the drive shaft, the relative bearing play of the outer bearing gap being greater than the relative bearing play of the inner bearing gap.

32. The turbocompressor according to claim 31, characterized in that the drive shaft is further mounted using a third bearing between the first bearing adjacent to the gearwheel and the second bearing adjacent to the compressor wheel, which particularly also has a floating bush.
